(19) United States
(12) Patent Application Publication
(10) Pub. No.: US 2026/0040414 A1
(43) Pub. Date: Feb. 5, 2026

(54) MICROWAVE-ASSISTED PROCESSING APPARATUS, MICROWAVE HEATING DEVICE, AND USE OF SAME

(71) Applicant: TRUMPF HÜTTINGER GMBH + CO. KG, Freiburg (DE)

(72) Inventors: Vasileios RAMOPOULOS, Stutensee (DE); Jan Peter ENGELSTAEDTER, Soelden (DE)

(21) Appl. No.: 19/351,327

(22) Filed: Oct. 7, 2025

Related U.S. Application Data
(63) Continuation of application No. PCT/EP2024/060087, filed on Apr. 12, 2024.

(30) Foreign Application Priority Data
Apr. 13, 2023 (DE) 10 2023 109 309.6

(51) Int. Cl. H05B 6/70; H05B 6/68; H05B 6/72

(52) U.S. Cl. CPC H05B 6/705; H05B 6/686; H05B 6/72

(57) ABSTRACT

A microwave-assisted processing apparatus includes a deformation apparatus configured to change a shape of a body, and a microwave heating device configured for heating of the body. The microwave heating device includes microwave antennas configured to emit microwave radiation directed onto the body, and semiconductor-based power amplifiers. each of which is configured to amplify a microwave signal applied thereto to a microwave power ≥100 W. Each microwave antenna is connected to at least one power amplifier. The power amplifiers are adjustable with respect to one another in terms of power outputs and phases thereof. Orientations and emission characteristics of the microwave antennas and adjustability of the power amplifiers are configured such that, during operation of the microwave heating device, a non-uniform temperature distribution in the body is generated, thereby generating thermal stresses in lattice structures of the body, which leads to splitting of the lattice structures.

### CROSS REFERENCE TO RELATED APPLICATIONS

This application is a continuation of International Application No. PCT/EP2024/060087 (WO 2024/213769 A1), filed on Apr. 12, 2024, and claims benefit to German Patent Application No. DE 10 2023 109 309.6, filed on Apr. 13, 2023. The aforementioned applications are hereby incorporated by reference herein.

### FIELD

Embodiments of the present invention provide a microwave-assisted processing apparatus having a deformation apparatus designed to change the shape of, in particular to fragment, a body comprising one or more hard-material components and having a microwave heating device designed for microwave-assisted heating of said body, as well as a microwave heating device designed for such a microwave-assisted processing apparatus. Furthermore, a use for changing the shape of such a body, in particular for fragmentation, having such a microwave heating device and/or microwave-assisted processing apparatus is disclosed.

### BACKGROUND

Microwave in this case refers to frequencies above 300 MHz.

‘Body having a hard-material component’ here means a body that contains ceramics or minerals, in particular those in the form of structures, particles or grains or domains. Such a body often has a particular hardness.

In order to process such bodies so as to change their shape, a deformation apparatus is often used.

Bodies having one or more hard-material components lead to increased wear in such deformation apparatuses. Depending on how hard the bodies or the components within them are, the wear can be considerable. This is undesirable.

Heating such bodies using heat sources, such as gas flames or electrically operated radiation sources, in order to change the body properties is known. However, such heating sources have the disadvantage that a lot of energy is released into the surroundings, which does not heat the body. This energy reduces efficiency and also unnecessarily heats the surroundings and possibly also a deformation apparatus, which can lead to further accelerated wear of same.

### SUMMARY

Embodiments of the present invention provide a microwave-assisted processing apparatus. The microwave-assisted processing apparatus includes a deformation apparatus configured to change a shape of a body that includes one or more hard-material components, and a microwave heating device configured for microwave-assisted heating of the body. The microwave heating device includes a plurality of microwave antennas arranged in a group such that relative movement is not possible among the plurality of microwave antennas. The plurality of microwave antennas is configured to emit microwave radiation directed onto the body in terms of direction, distribution, and intensity. The microwave heating device further includes a plurality of semiconductor-based power amplifiers, each of which is configured to amplify a microwave signal applied thereto to a microwave power ≥100 W. Each microwave antenna of the plurality of microwave antennas is connected to at least one semiconductor-based power amplifier of the plurality of semiconductor-based power amplifiers. The plurality of semiconductor-based power amplifiers is adjustable with respect to one another in terms of power outputs and phases thereof. Orientations and emission characteristics of the plurality of microwave antennas and adjustability of the plurality of semiconductor-based power amplifiers are configured such that, during operation of the microwave heating device, a non-uniform temperature distribution in the body is generated, thereby generating thermal stresses in lattice structures of the body, which leads to splitting of the lattice structures, so that the changing in the shape of the body is supported by the deformation apparatus.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 and FIG. 2 show two examples of a microwave-assisted processing apparatus with a microwave heating device; and

FIG. 3 shows an example of a semiconductor-based power amplifier.

### DETAILED DESCRIPTION

Embodiments of the invention provide an apparatus which is suitable for processing a body having one or more hard-material components with reduced wear of the deformation apparatuses.

According to some embodiments, a microwave heating device is designed for microwave-assisted heating of a body comprising one or more hard-material components and designed for a microwave-assisted processing apparatus, said microwave heating device comprising:
a) a plurality of microwave antennas designed and arranged in a group such that
   i) no relative movement is possible between the microwave antennas, and at the same time
   ii) by means of said microwave antennas, microwave radiation that can be directed in terms of direction, distribution and intensity can be radiated, and in particular focused, onto the body,
b) a plurality of semiconductor-based power amplifiers each designed to amplify a microwave signal that can be specified to them into a microwave power greater than or equal to 100 W,
c) each microwave antenna being connected to at least one semiconductor-based power amplifier, and
d) the power amplifiers being adjustable with respect to one another in terms of their power output and in terms of their phase,
e) the orientation and emission characteristics of the microwave antennas and the adjustability of the power amplifiers being designed such that, during operation of the microwave heating device, a non-uniform temperature distribution in the body is generated to generate thermal stresses in the lattice structures of the body, which leads to the splitting of the lattice structures.

The processing apparatus for which said microwave heating device is designed additionally has a deformation apparatus which is designed to change the shape of, in particular to fragment, the body. The generation of thermal stresses in the lattice structures of the body, which leads to the splitting of the lattice structures, can thus support the change in shape of the body by the deformation apparatus. “Support” in this case is understood to mean that the change in shape of the body by the deformation apparatus in combination with microwave-assisted heating of the body can be achieved with less energy consumption and/or less material wear on the deformation apparatus than without microwave-assisted heating of the body.

The term “change in shape” is used here as an umbrella term that encompasses deformation, transformation and separation, and therefore also includes crushing, disintegrating or abrasive processes such as drilling, milling, filing and sawing.

Hard-material components here are components that have a lattice structure due to their atomic bonding and that have a particularly high degree of hardness, in particular a Vickers hardness greater than 900 HV 10 or a Mohs hardness greater than or equal to 6.

These include, for example, technical ceramics such as aluminum oxide Al₂O₃, zirconium oxide ZrO₂, mixed oxides, e.g. ZrO₂/Al₂O₃, silicates, silicon carbide and silicon nitride Si₃N₄.

These also include minerals such as orthoclase, silicon, opal, quartz, topaz, corundum and diamond.

A body that has one or more hard-material components means, for example:
A homogeneous body which comprises one or more of the materials mentioned above under hard-material components in a homogeneous lattice structure, such as a monocrystalline body,
a polycrystalline body comprising almost exclusively the aforementioned grains or domains. Each grain or domain is crystalline across its grain width. The grain boundary separates the grains or domains where an adjacent grain or region has a different orientation than its neighbor. The grain boundary or domain boundary separates regions of different crystal structure.
A heterogeneous body that contains one or more of the components mentioned above under the definition of hard-material components in macrocrystalline particles. Macrocrystalline dimensions are those dimensions that are visible to the human eye without optical aids, in particular grains with a grain size of at least 1 mm.
A heterogeneous body which comprises one or more of the components mentioned above under the definition of hard-material components in the form of grains of at least microcrystalline dimensions. Microcrystalline dimensions are those dimensions that are still visible under an optical microscope, in particular grains having a grain width of 1 μm or more.

In particular, the body itself is a solid, i.e. it is so completely consolidated in a heterogeneous or homogeneous lattice structure that it can only be noticeably deformed with a large pressure, in particular more than 1 MPa.

Such a deformation apparatus can be, for example,
a pressure application apparatus,
a force application apparatus,
a material removal apparatus and/or an
impulse application apparatus.

This may include, for example: a press, a bending machine, a hammer, a shredder, a drill, a milling cutter, a file, a knife, a saw, a chisel.

Such a deformation apparatus may alternatively or additionally also be a cooling apparatus which is designed to change the shape of, in particular to fragment, such a body. This could be, for example, a flush with liquid nitrogen.

Such a deformation apparatus may alternatively or additionally also be a vibration coupling apparatus which is designed to change the shape of, in particular to fragment, such a body. This could be, for example, an ultrasound coupling apparatus.

In one aspect, the microwave heating device and in particular the entire microwave-assisted processing apparatus are designed for use in a free field. This means that the microwave energy cannot propagate in a specified cavity and form resonances there, but rather propagates freely and/or in an uncontrolled manner. This is uncontrolled because the free field is to be understood as a space with effects on the propagating microwave radiation. These effects may initially be unknown.

The free field may, for example, contain additional body units that absorb and/or reflect the microwave energy.

The electromagnetic properties of these additional body units may be unknown, in particular their effect on microwave propagation. For example, a body located in the ground can be heated by the microwave heating device as described and deformed by the deformation apparatus. What is around the body and in particular behind the body from the perspective of the microwave antennas may be at least partially unknown. Therefore, the effect of these body units on microwave energy may also be unknown. Such arrangements are understandably more difficult to control than arrangements in a cavity in which a known body is introduced for microwave heating.

In one aspect, the power amplifiers are also adjustable in terms of their frequency, in particular separately from one another.

The adjustability of the phase relationship between individual power amplifiers and at the same time the power output and in particular the frequency, allows the beam direction, which is also referred to as the ‘lobe’, to be influenced. Furthermore, the focus of the microwave power can be defined in a targeted manner by the number of power amplifiers used. Furthermore, such a configuration enables free power transfer over a much greater distance. Such a system provides a robust configuration that is less sensitive to material changes.

Further advantages are: low weight; reduced power losses; stronger focusing of the microwaves at greater distances; possibility of pivoting the main beam direction by varying the phase and, in particular, the frequency ratios between the power amplifiers.

In one aspect, at least one, in particular each, microwave antenna is connected to at least two semiconductor-based power amplifiers, the power outputs of which are connected together, in particular via a combiner. This allows a greater power to be applied to this microwave antenna and the power to be adjusted over a wider range.

In one aspect, a control circuit is provided to adjust the power amplifiers in terms of their power output and in terms of their phase with respect to one another and/or in terms of their frequency.

In one aspect, at least four microwave antennas are provided. This further enhances the benefits mentioned above.

In one aspect, at least four power amplifiers are provided. This also further improves the advantages mentioned above.

In one aspect, the power amplifiers can be varied with respect to one another in terms of their power output and/or their frequency and/or in terms of their phase such that different distribution functions, such as ramps, of the power output and/or frequency and/or phase can be run with respect to one another. This also further improves the advantages mentioned above.

In one aspect, the result of the varying can be monitored by sensors. This allows conclusions to be drawn about the result. This also further improves the advantages mentioned above.

In one aspect, the control circuit is designed such that it collects data during result monitoring and assigns the data to an evaluation and creates a profile from the assignment to data evaluation and the data and can further improve this profile with additional data.

In one aspect, at least one, in particular each, semiconductor-based power amplifier comprises: a transistor, in particular an LDMOS transistor. These transistors are considered to be particularly robust and can be used particularly efficiently for the frequencies mentioned above.

In one aspect, the transistor is a GaN-based transistor. It became apparent during the development phase that such transistors are particularly well suited for this application because they are particularly well suited to high frequencies and high temperatures.

In one aspect, at least one, in particular each, semiconductor-based power amplifier comprises: at least two transistors, in particular connected together in a push-pull circuit. This allows very efficient power amplifiers to be built.

In one aspect, at least one, in particular each, semiconductor-based power amplifier comprises: at least one balun. This allows the use of power amplifiers with very low weight and improved efficiency.

In one aspect, at least one, in particular each, semiconductor-based power amplifier comprises: at least one impedance matching circuit. This can reduce reflections and improve the efficiency of the power amplifiers.

In one aspect, at least one, in particular each, semiconductor-based power amplifier comprises: at least one circulator.

In one aspect, at least one, in particular each, semiconductor-based power amplifier comprises: at least one attenuator designed to absorb more power at at least one, in particular at several, frequencies different from the operating frequency range than in the operating frequency range.

In one aspect, at least one, in particular each, microwave antenna is provided with a casing which protects against dust and/or moisture but is permeable to microwaves. In this way, the microwave antenna(s) can be protected when they are exposed to harsh environments, e.g. moisture or dust due to processing of the body.

For example, the following can be provided as a microwave antenna:
a rod antenna,
a coaxial antenna,
a dipole antenna,
a waveguide system,
a patch antenna.

The antenna shape can be used to advantageously adjust the wave propagation.

In one aspect, a measuring system is provided for determining the power in the forward direction and/or reverse direction, in particular comprising a directional coupler. This also allows conclusions to be drawn about the result. This also further improves the advantages mentioned above. Alternatively or additionally, the voltage and/or current can also be determined.

In one aspect, at least one, in particular each, power amplifier is adjustable in terms of its power output and in terms of its phase relative to another power amplifier such that the penetration depth of the emitted microwaves into the body can be specified. This also further improves the advantages mentioned above.

In one aspect, at least one, in particular each, power amplifier is adjustable in terms of its power output and in terms of its phase relative to another power amplifier such that one power amplifier, in particular a plurality of power amplifiers, can be operated in a pulsed manner with a pulse frequency that is lower than a frequency of the operating frequency range, and that in particular in this way a higher power output can be delivered by the power amplifier during the pulse than that for which it is designed in continuous operation.

Preferred operating frequency ranges are, for example, ranges from 400 MHz to 500 MHz, from 900 MHz to 930 MHz, from 2.4 GHz to 2.5 GHz or from 5.7 GHz to 5.9 GHZ.

Preferred pulse frequencies are 1 kHz to 500 kHz. Pulsing can be carried out between several power levels. In particular, one of the power levels may be zero.

In one aspect, the object is achieved by a microwave-assisted processing apparatus, comprising:
a microwave heating device as described above, and
a deformation apparatus designed to change the shape of, in particular to fragment, the body.

In particular if the body is to be fragmented, special temperature differences in the body and/or in the components contained therein are necessary in order to destabilize their lattice structures, and in particular even to break them up. The aspects described above are particularly well suited for this purpose, since the microwave power can be focused in a targeted manner and most of the energy can be introduced into the body in one lobe.

In one aspect, the object is achieved by means of the use of a microwave heating device and/or a microwave-assisted processing apparatus as described above for microwave-assisted heating of a body comprising a hard-material component, wherein, during operation of the microwave heating device, a non-uniform temperature distribution is generated in the body to generate thermal stresses in the lattice structures of the body and/or the hard-material components, which leads to the splitting of the lattice structures of the body and/or of the hard-material components, for the targeted loosening of the body, in particular in order to prepare and/or support processing, particularly preferably fragmentation by a deformation apparatus.

All aspects and effects described above can be used to advantage in this way. This usually requires extensive testing to determine the setting that is most beneficial for each individual body. A reliable prediction of the probability of success is generally not possible and the prospects of success can only be determined after the tests have been carried out and evaluated.

Various embodiments of the invention are described below by way of example with reference to the drawings. Identical items have the same reference signs.

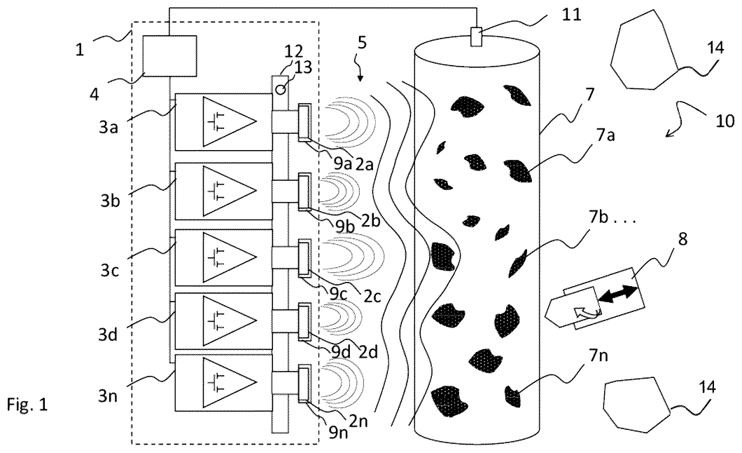

FIG. 1 shows a first microwave-assisted processing apparatus 10 with a first microwave heating device 1. The microwave heating device 1 is designed for microwave-assisted heating of a body 7 comprising a plurality of hard-material components 7a, 7b, . . . 7n. The microwave heating device 1 is also designed for a microwave-assisted processing apparatus 10 having a deformation apparatus 8 designed to change the shape of, in particular to fragment, the body 7. The microwave heating device 1 comprises:
a plurality of microwave antennas 2a-2n, designed and arranged in a group such that they allow microwave radiation 5, which can be directed in terms of direction, distribution and intensity, to be radiated onto the body 7 comprising a plurality of hard-material components 7a, 7b, . . . 7n, and
a plurality of semiconductor-based power amplifiers 3a-3n each designed to amplify a microwave signal that can be specified to them to a microwave power greater than or equal to 100 W. Each microwave antenna 2a-2n is connected to a semiconductor-based power amplifier 3a-3n. The power amplifiers 3a-3n are adjustable with respect to one another in terms of their power output and in terms of their phase as well as in terms of their frequency. The orientation and emission characteristics of the microwave antennas 2a-2n and the adjustability of the power amplifiers 3a-3n are designed such that, during operation of the microwave heating device 1, a non-uniform temperature distribution is generated in the body 7 to generate thermal stresses in the lattice structures of the body 7. These thermal stresses can lead to the splitting of the lattice structures. If the deformation apparatus 8 is configured as a cooling apparatus, e.g. as a flushing apparatus with liquid gas, such as nitrogen, it can also be designed to change the shape of, in particular to fragment, such a body, since it can further increase the thermal stresses.

The microwave-assisted processing apparatus 10, in particular the microwave heating device 1, further comprises: a control circuit 4 which is configured to adjust the power amplifiers 3a-3n in terms of their power output and in terms of their phase with respect to one another and/or in terms of their frequency. The result of varying these settings can be monitored by one or more sensors 11. The microwave antennas 2a-2n are each surrounded by a casing 9a-9n which protects against dust and/or moisture but is permeable to microwaves.

The control circuit 4 is further configured such that it collects data during the result monitoring and assigns the data to an evaluation and creates a profile from the assignment to data evaluation and the data and can further improve said profile with additional data.

The body is shown here in a cylindrical shape. However, other shapes are also conceivable. In particular, the body may also be much larger, and only a part of it may be treated with the microwave heating device 1. This can be useful, for example, when drilling in bodies comprising minerals. Even then, the microwave radiation 5 can be used due to its ability to be directed in such a way that the body is heated with the necessary temperature gradients at the desired location for deformation.

The microwave heating device 1 is designed in this case for use in a free field. This means that the microwave energy cannot propagate in a specified cavity and form resonances there, but propagates freely.

The free field may comprise further body units 14 that absorb and/or reflect the microwave energy. The electromagnetic properties of these additional body units 14 may be unknown, in particular their effect on microwave propagation. For example, a body 7 located in the ground can be heated by the microwave heating device as described and deformed by the deformation apparatus 8. It may be at least partially unknown what is around the body 7 and in particular behind the body from the perspective of the microwave antennas 2a-2n. Therefore, the effect of these body units 14 on the microwave energy may also be unknown. Such arrangements are understandably more difficult to control than arrangements in a cavity in which a known body is introduced for microwave heating.

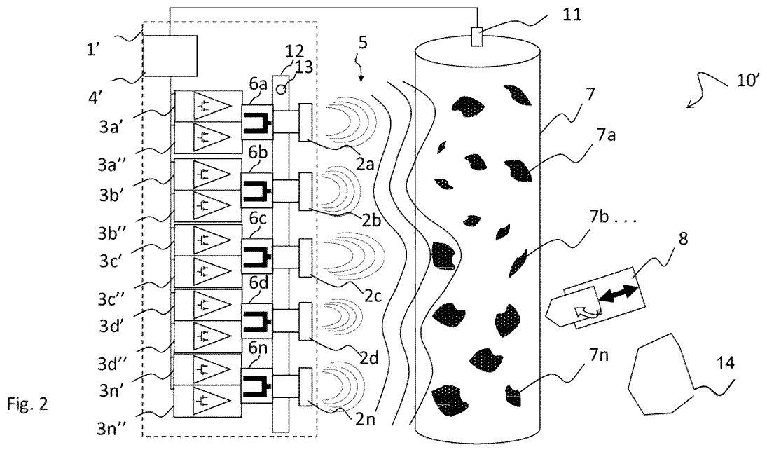

FIG. 2 shows a second microwave-assisted processing apparatus 10′ with a second microwave heating device 1′. This differs from the first microwave heating device 1 of FIG. 1 by the use of a plurality of semiconductor-based power amplifiers 3a′-3n′, 3a″-3n″ for each microwave antenna 2a-2n. When the same reference signs as in FIG. 1 have been used, the corresponding apparatuses are directly comparable with those in FIG. 1. For example, two power amplifiers 3a′, 3a″ are connected at their outputs to two inputs of a combiner 6a. The output of the combiner 6a is then connected to the microwave antenna 2a.

Similarly, two power amplifiers 3b′, 3b″ are connected at their outputs to two inputs of a combiner 6b. The output of the combiner 6b is then connected to the microwave antenna 2b.

Similarly, two power amplifiers 3c′, 3c″ are connected at their outputs to two inputs of a combiner 6c. The output of the combiner 6b is then connected to the microwave antenna 2c.

Similarly, two power amplifiers 3d′, 3d″ are connected at their outputs to two inputs of a combiner 6d. The output of the combiner 6d is then connected to the microwave antenna 2d.

This can be done using additional power amplifiers. For example, two power amplifiers 3n′, 3n″ are connected at their outputs to two inputs of a combiner 6n. The output of the combiner 6n is then connected to the microwave antenna 2n.

The control circuit 4′ is configured in this case to adjust the power amplifiers 3a′-3n′, 3a″-3n″ in terms of their power output and in terms of their phase with respect to one another and/or in terms of their frequency.

The casings 9a-9n which protect against dust and/or moisture but are permeable to microwaves are not shown in FIG. 2, but can be provided in this case as well.

The control circuit 4, 4′ may comprise:
an input device, such as a data interface, which may be wired or wireless, a keyboard, a touchpad, a coordinate setting apparatus, etc.;
a data processing circuit, such as a programmable logic device (PLD), FPGA, a microprocessor, a signal processor or similar circuit parts;
a data storage device which can store digital data permanently or volatilely, such as a ROM or RAM, flash memory or by magnetic and/or optical methods;
a data output device, such as a data interface, which may be wired or wireless, a screen, display, indicator light, sound or vibration device or similar components.

The sensor(s) 11 can be connected to this control circuit 4, 4′. They can be configured to determine the shape, condition, distance, structure, temperature and other properties of the body. They can determine this using imaging methods, for example. It is conceivable to use electromagnetic waves for this purpose, in particular in the range of light that is visible to the human eye. However, electromagnetic waves in other wavelength ranges, such as the X-ray range, are also conceivable. In addition to electromagnetic waves, sound waves, in particular ultrasonic waves, can also be used.

The semiconductor-based power amplifiers 3a-3n, 3a′-3n′, 3a″-3n″ can each be replaced individually. If one of these power amplifiers fails, the microwave heating device 1, l′ can continue to operate.

The semiconductor-based power amplifiers 3a-3n, 3a′-3n′, 3a″-3n″ and/or combiners 6a-6n can each be arranged individually or together on a common cooling unit 12, through which a cooling liquid 13 flows in particular. The cooling unit 12 can be designed at least partially as a heat sink, in particular as a cooling plate. The cooling unit 12 can be composed of a plurality of parts made of different materials. Examples of such a cooling unit 12 are disclosed and described in detail in the following publications: WO 2019/072894 A1, WO 2013/068004 A1, WO 2014/207185 A1.

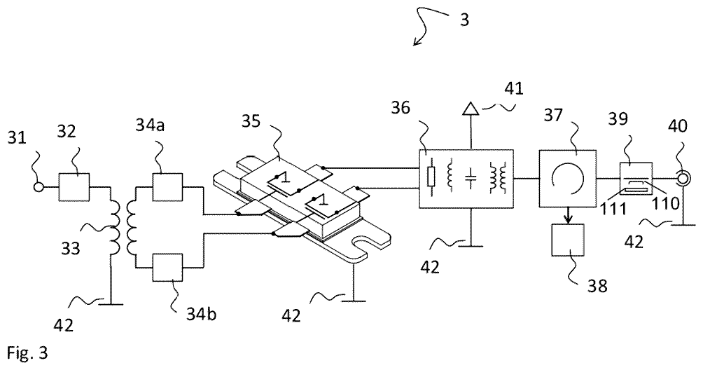

FIG. 3 shows an example of a semiconductor-based power amplifier 3 as shown in FIGS. 1 and 2 with the reference signs 3a-3n, 3a′-3n′, 3a″-3n″. This semiconductor-based power amplifier 3 has the following circuit components:
a signal input 31 to which a small microwave signal can be connected;
an output terminal 40 designed to carry the power amplified by the power amplifier 3;
a balun 33, designed as a transformer and connected on the input side to the signal input 31 and to a ground connection 42;
a matching circuit 32, which may comprise filters and/or attenuators and is connected between the signal input 31 and the balun 33.
a module comprising two transistors 35, in particular both designed as LDMOS transistors and connected together in a push-pull circuit. The source terminals of the transistors 35 are connected to a ground connection 42. The gate terminals of the transistors 35 are connected to two output-side terminals of the balun 33;
two additional matching circuits 34a, 34b, which may comprise filters and/or attenuators and which are each connected between the balun 33 and the gate terminals of the transistors 35;
an impedance matching circuit 36, which may comprise a balun, filters and/or attenuators and which is connected on the input side to the drain terminals of the transistors 35;
a circulator 37 which comprises a connection to the impedance matching circuit 36 and is connected to a compensator 38, which may be, for example, a resistor or attenuator;
a measuring system 39 which is configured to capture a power-dependent quantity at the output of the power amplifier 3 and is connected to both the circulator 37 and the output terminal 40.

The measuring system 39 may comprise a measuring device 110, e.g. a directional coupler, and a processing device 111, e.g. a programmable logic unit (PLD), an FPGA or a microprocessor.

A typical measuring system 39 is shown, for example, in one of the following publications: WO2019/185424 A1, WO2013/143537 A1, US2009/0140722 A1, US2006/0232265 A1 and DE 20 2011 051 371 U1.
The processing device 111 can be designed to determine a workpiece-specific frequency, in particular a resonance frequency, which arises in the body 7 by means of the measuring device 110. This can be used to treat the body 7 in an even more targeted manner with microwave radiation 5.
The processing device 111 can be designed to determine, by means of the measuring device 110, a workpiece-specific frequency, in particular a resonance frequency, which is caused by one or more of the body units 14. This can be used to treat the body 7 in an even more targeted manner with microwave radiation 5.
The processing device 111 can further be designed to track a curve of a shift in the workpiece-specific frequency, in particular resonance frequency, during operation. The term “curve” here refers in particular to a curve over time. By considering not only a value but also a curve, an improved determination of the properties of the body 7 and/or the body units 14 is possible.
The processing device 111 can be designed to compare the curve of the shift in the workpiece-specific frequency, in particular resonance frequency, with a stored workpiece-dependent curve and is in particular further designed to determine, and in particular output, a status message that corresponds to a process progress. By comparing with a stored workpiece-dependent curve, improved determination of the properties of the body 7 and/or the body units 14 is possible.
The result of this comparison may lead to or correspond to the status message mentioned.

In such a circuit arrangement, the semiconductor-based power amplifier 3 can advantageously be operated as a push-pull amplifier. It can be used in a plurality of different operating modes, such as class A, B, AB, C, D, E, F, F⁻¹, in a switching manner or in linear mode. This can be used very advantageously for efficiency and/or control accuracy. Not all circuit components are mandatory; individual ones can also be connected together in a different configuration to form a semiconductor-based power amplifier 3.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A microwave-assisted processing apparatus, comprising:
a deformation apparatus configured to change a shape of a body, the body comprising one or more hard-material components, and
a microwave heating device configured for microwave-assisted heating of the body,
wherein the microwave heating device comprises:
a plurality of microwave antennas arranged in a group such that relative movement is not possible among the plurality of microwave antennas, wherein the plurality of microwave antennas is configured to emit microwave radiation directed onto the body in terms of direction, distribution, and intensity, and
a plurality of semiconductor-based power amplifiers, each of which is configured to amplify a microwave signal applied thereto to a microwave power ≥100 W,
wherein each microwave antenna of the plurality of microwave antennas is connected to at least one semiconductor-based power amplifier of the plurality of semiconductor-based power amplifiers,
wherein the plurality of semiconductor-based power amplifiers is adjustable with respect to one another in terms of power outputs and phases thereof,
wherein orientations and emission characteristics of the plurality of microwave antennas and adjustability of the plurality of semiconductor-based power amplifiers are configured such that, during operation of the microwave heating device, a non-uniform temperature distribution in the body is generated, thereby generating thermal stresses in lattice structures of the body, which leads to splitting of the lattice structures, so that the changing in the shape of the body is supported by the deformation apparatus.

2. The microwave-assisted processing apparatus according to claim 1, wherein the deformation apparatus comprises a cooling apparatus configured to change the shape of the body.

3. The microwave-assisted processing apparatus according to claim 1, wherein the deformation apparatus comprises a vibration coupling apparatus configured to change the shape of the body.

4. The microwave-assisted processing apparatus according to claim 1, wherein the microwave heating device is configured for use in a free field, wherein
the free field has body units that absorb and/or reflect microwave energy, and
electromagnetic properties of the body units are unknown.

5. The microwave-assisted processing apparatus according to claim 1, wherein the microwave heating device comprises a measuring system, the measuring system comprises a measuring device and a processing device, the processing device being configured to determine, by using the measuring device, a workpiece-specific frequency that arises in the body.

6. The microwave-assisted processing apparatus according to claim 5, wherein the processing apparatus is configured to track a curve of a shift in the workpiece-specific frequency during operation.

7. The microwave-assisted processing apparatus according to claim 6, wherein the processing apparatus is configured to compare the curve of the shift in the workpiece-specific frequency with a stored workpiece-dependent curve, and to determine a status message corresponding to a process progress.

8. The microwave-assisted processing apparatus according to claim 1, wherein at least one microwave antenna of the plurality of microwave antennas is connected to at least two semiconductor-based power amplifiers of the plurality of semiconductor-based power amplifiers, the power outputs of the at least two semiconductor-based power amplifiers being connected together.

9. The microwave-assisted processing apparatus according to claim 1, further comprising a control circuit configured to adjust the plurality of semiconductor-based power amplifiers in terms of the power output and the phases thereof with respect to one another, and/or frequencies thereof.

10. The microwave-assisted processing apparatus according to claim 1, wherein the plurality of microwave antennas comprises at least four microwave antennas.

11. The microwave-assisted processing apparatus according to claim 1, wherein the plurality of semiconductor-based power amplifiers comprises at least four semiconductor-based power amplifiers.

12. The microwave-assisted processing apparatus according to claim 1, wherein the plurality of semiconductor-based power amplifiers is capable of being varied with respect to one another in terms of the power outputs and/or frequencies thereof and/or phases thereof such that different distribution functions of the power outputs and/or frequencies and/or phases are capable of being run with respect to one another.

13. The microwave-assisted processing apparatus according to claim 12, wherein a result of varying the plurality of semiconductor-based power amplifiers is capable of being monitored by one or more sensors.

14. The microwave-assisted processing apparatus according to claim 13, further comprising a control circuit configured to collect data while the result is being monitored, assign the data to an evaluation, and create a profile from the assigning the data to the evaluation, wherein the data is usable to improve the profile with additional data.

15. The microwave-assisted processing apparatus according to claim 1, wherein at least one semiconductor-based power amplifier of the plurality of semiconductor-based power amplifiers comprises a transistor.

16. The microwave-assisted processing apparatus according to claim 1, wherein at least one semiconductor-based power amplifier of the plurality of semiconductor-based power amplifiers comprises at least two transistors connected together in a push-pull circuit.

17. The microwave-assisted processing apparatus according to claim 1, wherein at least one semiconductor-based power amplifier of the plurality of semiconductor-based power amplifiers comprises at least one balun.

18. The microwave-assisted processing apparatus according to claim 1, wherein at least one semiconductor-based power amplifier of the plurality of semiconductor-based power amplifiers comprises at least one impedance matching circuit.

19. The microwave-assisted processing apparatus according to claim 1, wherein at least one semiconductor-based power amplifier of the plurality of semiconductor-based power amplifiers comprises at least one circulator.

20. The microwave-assisted processing apparatus according to claim 1, wherein at least one semiconductor-based power amplifier of the plurality of semiconductor-based power amplifiers comprises at least one attenuator configured to absorb more power at one or more frequencies which are outside an operating frequency range than in the operating frequency range.

21. The microwave-assisted processing apparatus according to claim 1, wherein at least one microwave antenna of the plurality of microwave antennas is provided with a casing which protects against dust and/or moisture but is permeable to microwaves.

22. The microwave-assisted processing apparatus according to claim 1, further comprising a measuring system for determining power in a forward direction and/or a reverse direction.

23. The microwave-assisted processing apparatus according to claim 1, wherein at least one semiconductor-based power amplifier of the plurality of semiconductor-based power amplifiers is adjustable in terms of the power output and the phase thereof relative to another semiconductor-based power amplifier such that a penetration depth of the emitted microwave radiation into the body is capable of being specified.

24. The microwave-assisted processing apparatus according to claim 1, wherein at least one semiconductor-based power amplifier of the plurality of semiconductor-based power amplifiers is adjustable in terms of the power output and the phase thereof relative to another semiconductor-based power amplifier such that the at least one semiconductor-based power amplifier is capable of being operated in a pulsed manner with a pulse frequency that is lower than a frequency of an operating frequency range.
